(19) United States
(12) Patent Application Publication
(10) Pub. No.: US 2026/0226960 A1
(43) Pub. Date: Aug. 6, 2026

(54) MULTI-LAYER REINFORCED BELT

(71) Applicant: GATES CORPORATION, Denver, CO (US)

(72) Inventors: Thomas S. MOSS, III, Englewood, CO (US); Walt LIFSEY, Denver, CO (US)

(73) Assignee: GATES CORPORATION, Denver, CO (US)

(21) Appl. No.: 19/153,048

(22) PCT Filed: Feb. 2, 2024
(86) PCT No.: PCT/US2024/014328

§ 371 Date: Aug. 1, 2025

Related U.S. Application Data
(60) Provisional application No. 63/482,996, filed on Feb. 2, 2023.

(51) Int. Cl. F16G 1/10; F16G 1/28; F16G 5/08

(52) U.S. Cl. CPC F16G 1/10; F16G 1/28; F16G 5/08

(57) ABSTRACT

A multi-layer reinforced industrial belt is described, the belt generally including a plurality of cords embedded within a body portion of the belt and a reinforcement fabric layer embedded within the body portion of the belt between the plurality of cords and the contact surface of the belt. In some embodiments, the cords are oriented slightly off parallel with the direction of travel of the belt, while either the first or second fibers of the woven reinforcement fabric layer are aligned either in parallel with the direction of travel of the belt or at an angle with respect to the direction of travel of the belt. When the first or second fibers of the reinforcement fabric layer are oriented at an angle with respect to the direction of travel, the angle may be in an opposite direction of the angle of the cords with respect to the direction of travel.

### CROSS-REFERENCE TO RELATED APPLICATIONS

This application claims priority to International Application No. PCT/US2024/014328 filed Feb. 2, 2024, which claims priority to U.S. Provisional Patent Application Ser. No. 63/482,996 filed Feb. 2, 2023, both of which are incorporated herein in their entirety by reference

### TECHNICAL FIELD

The present application relates to industrial belts, and more specifically, to multi-layer reinforced industrial belts. The multi-layer reinforced belt described herein may include embedded therein a woven reinforcement fabric layer and a plurality of cords, where the orientation of the woven reinforcement fabric layer and the cords is intentionally misaligned to provide various improvements, including resistance to belt tracking.

### BACKGROUND

With reference to FIG. 1, a previously known configuration for an industrial belt 100 is shown, the belt 100 generally including a plurality of reinforcing cords 110 embedded within the body portion 120 of the belt 100 and extending in a direction substantially parallel to the direction of travel of belt 100 (direction of travel of belt indicated by the arrow labeled 101). The belt 100 may further include a backing layer 140 on the back surface of the belt 100 as is well known in the art.

The belt shown in FIG. 1 further includes surface features formed in the contact surface side of the belt 100, with the surface features shown in FIG. 1 being teeth 130 oriented generally perpendicular to the direction of travel 101 and extending along the entire length of the belt 100. While the belt 100 shown in FIG. 1 may therefore be considered a toothed belt, it should be appreciated that the general belt body configuration shown in FIG. 1 can also be used in any other type of belt, including belts having different surface features on the contact surface of the belt. For example, the surface features may alternatively be one or more ribs generally oriented generally parallel to the direction of travel 101. The contact surface of the belt may also be planar (i.e., include no surface features). Other belt types that may generally use the belt body configuration shown in FIG. 1 include V-belts, micro-V belts, timing belts, synchronous belts, friction belts, etc.

With reference now to FIG. 1A, a simplified top view of the belt 100 shown in FIG. 1 is provided. For sake of simplicity, FIG. 1A shows only a single cord 110, though it should be appreciated that the belt 100 may include a plurality of cords 100 across the entire width of the belt 100. FIG. 1A illustrates that, generally speaking, the orientation of the cords 110 embedded within the belt body portion 120 of the belt 100 is not perfectly parallel to the direction of travel 101 of the belt 100. As such, the phrase “substantially parallel” as used in the preceding paragraphs is intended to mean close to parallel, not actually parallel.

With respect to the orientation or alignment of the cords 110 embedded within the body portion 120 of the belt 100, the cords 110 are generally oriented at an angle A with respect to the direction of travel 101. Angle A may be referred to as a helical angle, a walk angle, and/or a rack angle. This is typically due to the manner in which the cords are wound around the body portion material of the belt during manufacture of the belt. The specific value for angle A is generally not limited, though angle A is typically not excessively large. In some embodiments, angle A is in the range of greater than 0° to 5°, though larger upper limits to the range, such as 10°, 15°, 20°, or 25°, are also possible. The orientation of the cords in a direction substantially parallel, but not perfectly parallel, with the direction of travel of the belt 100 may result in performance issues with respect to the belt 100.

In one specific example, the cords that are slightly off parallel to the direction of travel of the belt can cause the belt to track to the side during use, rather than solely in the direction of travel. In some specific applications, e.g., personal mobility such as e-bikes, the frames of the vehicles are flexible, causing the sprockets to move in lateral directions, which results in more forces being applied to the sides of the belt. While the flexibility of the frame is generally instantaneous (meaning the frame can return to its normal, non-flexed state quickly, making the tracking of the belt correspondingly brief), this can lead to issues with respect to load application to the belt.

Regardless of cord orientation, the cords can also often create a weak point in the belt when high loads are applied. This weak point is due to the relatively low surface area provided by the cords as an area of adhesion between the compound material of the belt and the cords. When high loads are applied, the belt may tear at the interface between the cords and the compound material, resulting in failure of the belt.

Further still, the material of the cords may be an expensive aspect of the belt when the cords serve as the primary means for improving the strength and load carrying ability of the belt. The presence of the cords in the belt may therefore drive up the overall cost of the belt.

To respond to the off-axis loading of the reinforcement cords, additional cords may be required for the application. Further, the use of high-performance material systems at higher manufacturing expense may be required.

For at least these reasons, a need exists for an improved industrial belt that does not suffer from the issues described above.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

In some embodiments, a multi-layer reinforced belt is disclosed, the multi-layer reinforced belt generally including a main body portion extending from a back surface to a contact surface of the multi-layer reinforced belt; a plurality of cords embedded within the main body portion, each of the plurality of cords having a longitudinal axis that is oriented substantially parallel to the direction of travel of the belt; and a reinforcement fabric layer embedded within the main body portion between the plurality of cords and the contact surface of the belt. The reinforcement fabric layer may be in the form of a weave of first fibers and second fibers, the first fibers being substantially perpendicular to the second fibers. The orientation of the reinforcement fabric layer within the main body portion is such that neither the first fibers nor the second fibers are aligned in parallel with the longitudinal axis of the plurality of cords.

These and other aspects of the technology described herein will be apparent after consideration of the Detailed Description and Figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1 is a perspective view of a portion of a toothed belt showing the cross-sectional view of the belt in both the longitudinal and transverse directions.

FIG. 1A is a simplified schematic top view of the toothed belt shown in FIG. 1.

FIG. 2 is a perspective view of a portion of a toothed belt showing the cross-sectional view of the belt in both the longitudinal and transverse directions, the toothed belt being configured in accordance with various embodiments described herein.

FIG. 2A is a simplified schematic side view of the toothed belt shown in FIG. 2.

FIG. 3A is a simplified schematic top view of a multi-layer reinforcement belt configured in accordance with various embodiments described herein.

FIG. 3B is a simplified schematic top view of a multi-layer reinforcement belt configured in accordance with various embodiments described herein.

### DETAILED DESCRIPTION

Embodiments are described more fully below with reference to the accompanying Figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense.

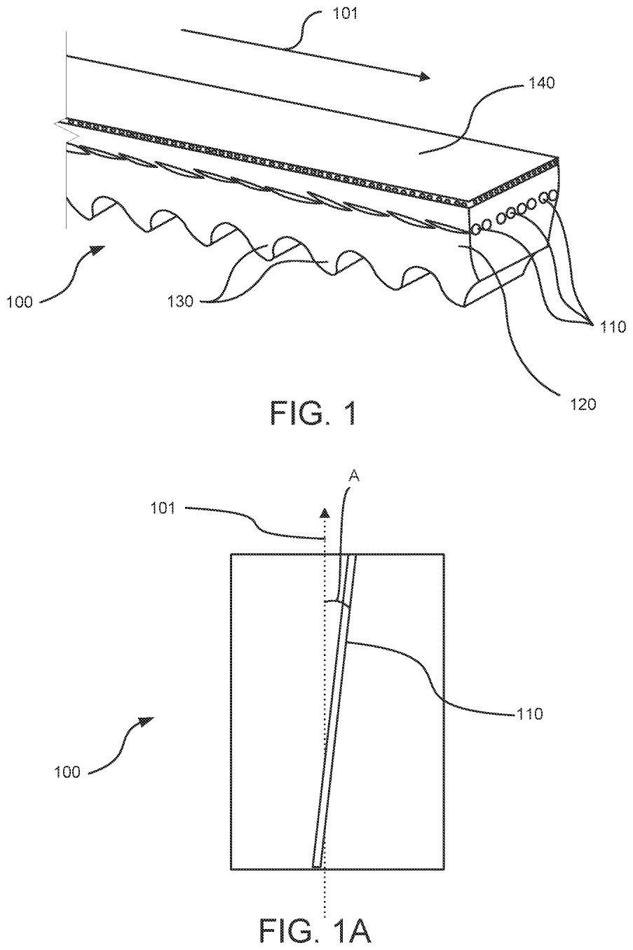

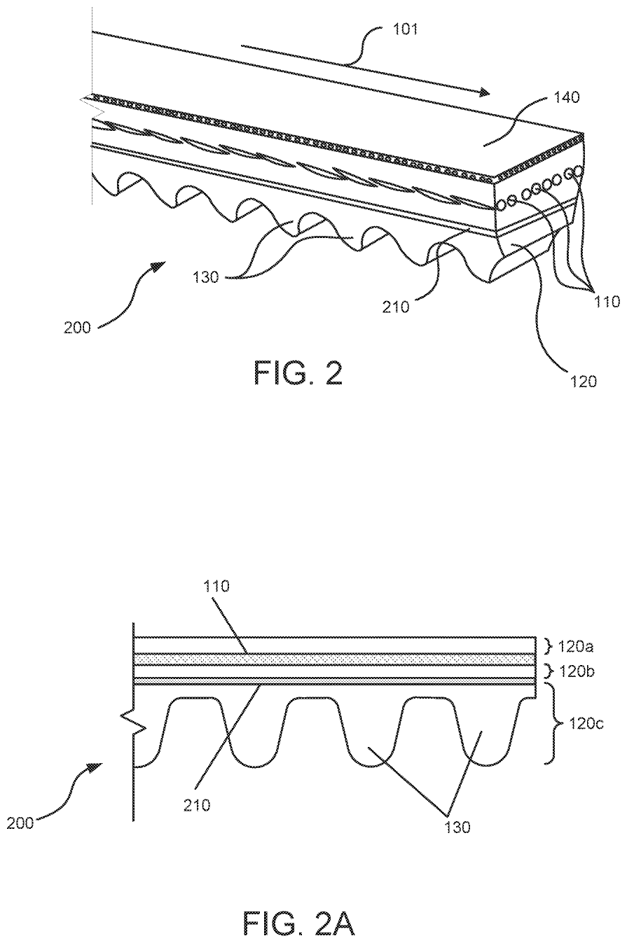

With respect to FIG. 2, a belt 200 similar in configuration to belt 100 shown in FIG. 1 generally includes a plurality of cords 110 aligned substantially parallel to the direction of travel 101, a body portion 120 in which the plurality of cords 110 are embedded, optional surface features 130 formed in the contact surface of the belt 200, and a backing layer 140 on the back surface of the belt 200. The belt 200 shown in FIG. 2 further includes a reinforcement fabric layer 210 also embedded within the body portion 120 of belt 200 and which is located between the plurality of cords 110 and the contact surface of the belt 200. In the case of the specific belt configuration shown in FIG. 2, in which the belt 200 includes teeth 130, the reinforcement fabric layer 210 is located between the plurality of cords 110 and the surface features/teeth 130.

In some embodiments, the fabric layer 210 has a generally woven construction comprising a weave of first fibers and second fibers, the first fibers being aligned generally perpendicular to the second fibers. The fabric layer may include multiple layers of this woven construction to create a more robust and thicker fabric layer 210. The specific material of the fabric layer 210 is generally not limited. In some embodiments, the material of the fabric layer 210 is interlock yarn twist (ITY) fabric. Other suitable materials for the fabric layer 210 include, but are not limited to, polyester, polyaramid, nylon, polypropylene, polyethylene, ceramic fibers, carbon fiber, and metal fibers.

In FIG. 2, the fabric layer 210 is shown as being spaced apart a distance from the layer of the plurality of cords 110. In such embodiments, material used for the body portion 120 of the belt 200 is located between the fabric layer 210 and the plurality of cords 110. In other embodiments, the fabric layer 210 may be positioned directly on or against the plurality of cords 110 such that there is direct contact between the plurality of cords 110 and the fabric layer 210. In either embodiment, the woven nature of the fabric layer 210 provides interstitial spaces within the fabric layer 210. In some embodiments, the material of the body portion 120 may extend through the fabric layer 210 by flowing through these interstitial spaces during manufacture of the belt 200. In some embodiments where fabric layer 210 is located close to or directly against the plurality of cords 110, the fabric layer 210 effectively serves to increase the surface area of the plurality of cords 110 and can thereby improve adhesion between the plurality of cords 110 and the material of the body portion 120 of the belt 200 when the material of the body portion 120 extends through the fabric layer 210 towards the plurality of cords 110. In embodiments where adhesion is improved due to these features, this may improve the overall load carrying capacity of the belt 200.

The dimensions of the reinforcement fabric layer 210 are generally selected such that the reinforcement fabric layer 210 extends across all or almost all of the width of the belt 200, and such that the fabric layer 210 extends the entire length of the belt 200. The thickness of the fabric layer 210 is generally not limited, though in some embodiments, the thickness of the fabric layer 210 is generally in the range of from about 0.3 to about 2.8 mm.

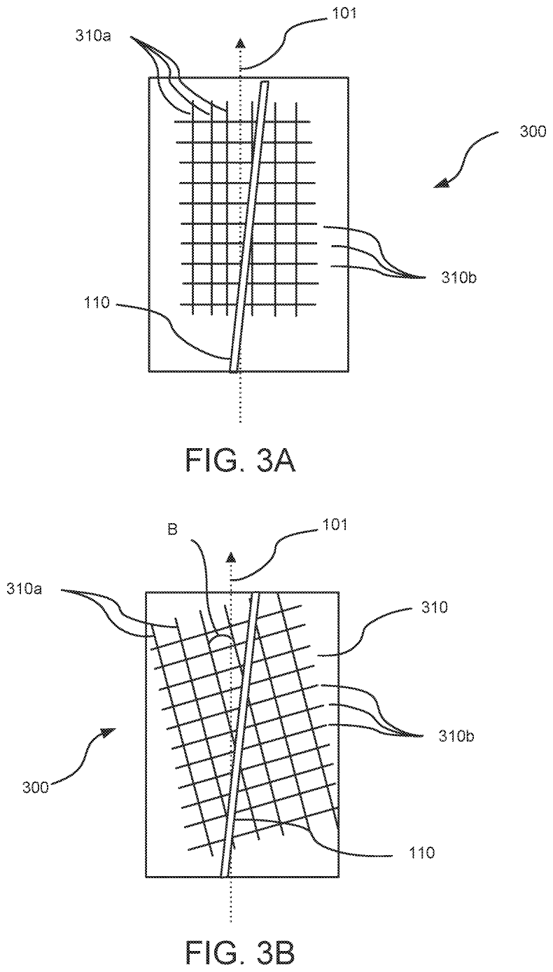

With reference to FIGS. 3A and 3B, different fabric layer orientations used in various embodiments described herein are illustrated. In FIG. 3A, a single cord 110 is shown for the sake of simplicity, though it should be appreciated that in a typical configuration, multiple cords 110 will be located across the width of the belt 300. FIG. 3A also shows the cord 110 being substantially parallel to the direction of travel 101, i.e., not parallel with the direction of travel 101, but forming an angle with the direction of travel 101 in the range of greater than 0° to, e.g., about 5°. FIG. 3A further shows the fabric layer 310 located between the plurality of cords 110 and the contact surface of the belt 300. Again for the sake of simplicity, only a portion of the fabric layer 310 is shown. In a typical configuration, the fabric layer 310 is coextensive with the width and length dimensions of the belt 300 such that the fabric layer 310 extends all the way to the sides of the belt 310 and runs the entire length of the belt 300.

As described previously, fabric layer 310 includes first fibers 310a and second fibers 310b woven together to form a weave of fabric material. The first fibers 310a are oriented generally perpendicular to the second fibers 310b. In the embodiment shown in FIG. 3A, the fabric layer 310 is oriented within the belt 300 such that the first fibers 310a are aligned in parallel with the direction of travel 101. Significantly, the fabric layer 310 is oriented such that the first fibers 310a are not parallel with the cords 110. As discussed in greater detail elsewhere within this disclosure, the fibers of the fabric layer 310 being non-parallel with the cords 110 helps to combat the lateral forces that may be caused by the angle of the cords 110 with respect to the direction of travel 101.

In FIG. 3B, an alternate configuration is illustrated wherein the fabric layer 310 is oriented within the belt such that the first fibers 310a are not parallel with either the direction of travel 101 or the cords 110. Instead, in this configuration, the angle formed between the first fibers 310a and the direction of travel 101 (labeled as angle B in FIG. 3B) is less than 0° relative to the angle formed between the direction of travel 101 and the cords 110. Put another way, when the cords 110 are angled in a clockwise direction from the direction of travel 101, the first fibers 310a are angled in a counterclockwise direction from the direction of travel 101. Put still another way, when all angles are measured from the direction of travel 101 in a common direction (e.g., clockwise), the first fibers are at an angle in the range of, e.g., greater than 340° to less than 360°. In some embodiments, the angle B is in the range of less than 0° to about −5°, though the range may extend to, e.g., −10°, −15°, −20°, −25°, etc. Regardless of the specific angle in which the first fibers 310a of the fabric layer 310 are oriented away from the direction of travel 101 in a direction opposite the angle formed between the cords 110 and the direction of travel, the effect is similar to that described previously with respect to the embodiment shown in FIG. 3A. That is to say, the orientation of the first fibers 310a of the fabric layer 310 helps to offset or counteract lateral forces that may be caused by the angle of the cords 110 within the belt 300 relative to the direction of travel 101.

With reference back to FIG. 2A, the material of the body portion 120 of the belt 200 is generally not limited, and can include any materials known to be suitable as compound material in industrial belts. In some embodiments, the material of the body portion 120 is a polyurethane. A single type of polyurethane can be used for the entirety of the body portion 120, i.e., for the area between the back surface and cords 110, the area between the cords 110 and the reinforcement fabric layer 210, and from the fabric layer 210 to the contact surface of the belt 200. In embodiments where the contact surface includes surface features (such as teeth 130 shown in FIG. 2A), the single polyurethane can also be used for the surface features. In other embodiments, two or more materials (e.g., two or more different types of polyurethane) are used for different portions of the main body 120. For example, the area between the back surface of the belt 200 and the cords 110 (labeled 120a in FIG. 2A) can be made from a first compound material, such as a first polyurethane having a first modulus. The area between the cords 110 and the fabric layer 210 (labeled 120b in FIG. 2A) can then be made from a second compound material, such as a second polyurethane having a second modulus different from the first modulus of the first polyurethane material used for the area between the back surface and the cords 110. The area from the fabric layer 210 to the contact surface (including surface features such as teeth, if included) (labeled 120c in FIG. 2A) can then be made from a third compound material, such as a third polyurethane having a third modulus, the third modulus being different from the first and second modulus. Each of the areas 120a, 120b, 120c can also be made from multiple layers of different compound material. For example, area 120a can include a first layer of polyurethane having a first modulus and a second layer of polyurethane having a second modulus. In another example, an inner portion of the teeth 130 is made from a third polyurethane having a third modulus and the exterior portion of the teeth is made from a fourth polyurethane having a fourth modulus.

When multiple types of compound materials (e.g., different types of polyurethanes) are used for various portions of the body portion 120, the different types of materials used can also be selected so as to have differences in other properties. For example, each type of material used can have a different adhesion property or curing property. In some embodiments, each material used for a different portion of the body portion has a modulus, an adhesion property, and a curing property, and at least one of these properties is different from the corresponding property in the other materials used. For example, if three different materials are used for three parts of the body portion, the first, second and third material may each have a different moduli, but similar or identical adhesion and curing property. In another example, if three different materials are used for three parts of the body portion, the first, second and third material may each have a different moduli, a different adhesion property and a different curing property.

In embodiments where multiple compound materials are used and in which area 120b between the cords 110 and the fabric layer 210 is provided (i.e., configurations where the fabric layer 120 is not directly against the cords 110), the belt 200 can be designed for the compound material in area 120c to extend through fabric layer 210 towards the cords 110, the compound material in area 120b to extend through the fabric layer 210 towards the contact surface, or a combination of both.

As described previously with respect to the discussion of the belt configuration shown in FIG. 1, the embodiments of a multi-layer reinforced belt having a reinforcement fabric layer disposed therein between the cords and the contact surface can be used with any type of industrial belt, including those that have surface features on the contact surface and those that do not. As such, the belt embodiments described herein may be for V-belts, micro-V belts, timing belts, flat or planar belts, ribbed belts, toothed belts, synchronous belts, or friction belts, as well as any other type of industrial belt.

In the embodiments discussed herein, the belt is described as including a plurality of cords embedded within the body portion of the belt. As shown in, e.g., FIG. 2, the cords extend across the width of the belt and are spaced very close together. In some embodiments, each cord may contact an adjacent cord, providing for a high density of cord material within the belt. In some embodiments, the presence of the fabric layer in the belt as described herein may improve the load carrying capabilities of the belt such that less cord material can be used in belt. Less cord material may be realized by spacing the cords farther apart from each other, meaning less densely packed cords in the belt. As the cords are generally an expensive component of the belt, the ability to use less cord in the belt is a cost savings measure that may reduce the overall cost of the belt. The cost of the fabric layer material is relatively cheap, and therefore the addition of the fabric layer to the belt does not offset the savings realized by using less cord material.

Methods of manufacturing the belt configurations described herein generally follow known slab building processes using a mold. For example, the manufacturing process may include depositing sequentially in a mold: a surface layer, a compound material (which may be molded into surface features such as teeth or ribs), the reinforcement fabric layer (deposited in a manner to ensure the desired orientation of the fibers of the reinforcement material relative to the direction of travel of the belt), optional compound material where the fabric layer and cords are not in contact, the cord material (wound around the previously deposited materials), compounds material, and an optional backing layer. Once all materials are deposited in the mold, a thermal cure step is used to stretch the surface layer, flow the compound material to form surface features based on the mold shape, and allow the compound material to flow through the fabric layer from above or below the fabric layer. The molded belt is then removed from the mold and subjected to any required post-processing, such as grinding, branding, singulation, etc.

The inclusion of a fabric layer in the belt as described herein can provide various benefits, some of which have been described previously. In the first instance, the fabric layer acts as a stabilizing member that counteracts some or all of the lateral forces that may be applied to the belt. In the example of the off-parallel orientation of the cords and how this may cause the belt to move in a lateral direction, the presence and orientation of the fabric layer as described herein may counteract this issue and keep the belt traveling only in the direction of travel. The presence and orientation of the fabric layer can also offset or smooth out other chronic or transient lateral forces that may be applied to the belt, such as in the case where the frame of a vehicle in which the belt is used (e.g., in an e-bike) flexes and moves the sprockets on which the belt is mounted, thus resulting in the application of lateral forces at various angular positions.

The multi-directionality of the fabric layer also serves to distribute loads carried by the belt in more than just the one direction that load may be distributed when only the cords are provided in the belt. When the fabric layer is oriented such that first fibers are parallel to the direction of travel, the second fibers provide load distribution in a transverse direction. When the fabric layer is oriented at an angle to the direction of travel, both the first and second fibers can distribute the load in directions other than the direction of travel. Because the fabric layer can distribute load in multiple directions, this can increase the overall load carrying capacity of the belt.

In view of the improve load distribution and load carrying capacity offered to the belt when the fabric layer is included as described herein, the belt can provide similar load carrying capabilities using less cord material. Because the cost of the cord is generally higher relative to the cost of the fabric layer material, the inclusion of the fabric layer and the elimination of cord material is a net reduction in the cost of the belt, thus making the belts less expensive to manufacture.

Further still, the presence of the fabric layer can increase the surface area of the cords, thus providing for better adhesion between the cords and the compound material used for the body portion of the belt. This strengthens the belt and allows the belt to carry more load before the belt may begin to separate and the interface between the cords and the compound material. Accordingly, the presence of the fabric layer and the attendant improvement in adhesion within the belt allows the belt to ultimately carry more load.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

I/We claim:

1. A multi-layer reinforced belt having a back surface and a contact surface opposite the back surface, the multi-layer reinforced belt comprising:
a main body portion extending from the back surface to the contact surface;
a plurality of cords embedded within the main body portion, each of the plurality of cords having a longitudinal axis that is oriented substantially parallel to the direction of travel of the belt; and
a reinforcement fabric layer embedded within the main body portion between the plurality of cords and the contact surface of the belt, the reinforcement fabric layer comprising a weave of first fibers and second fibers, the first fibers being substantially perpendicular to the second fibers;
wherein the orientation of the reinforcement fabric layer within the main body portion is such that neither the first fibers nor the second fibers are aligned in parallel with the longitudinal axis of the plurality of cords.

2. The multi-layer reinforced belt of claim 1, wherein an angle formed between the longitudinal axis of the plurality of cords and the direction of travel of the belt is from greater than 0° to 5°.

3. The multi-layer reinforced belt of claim 1, wherein each cord in the plurality of cords contacts an adjacent cord.

4. The muti-layer reinforced belt of claim 1, wherein each cord in the plurality of cords is spaced apart from an adjacent cord.

5. The multi-layer reinforced belt of claim 1, wherein the first fibers or the second fibers of the reinforcement fabric layer are aligned in parallel with the direction of travel of the belt.

6. The multi-layer reinforced belt of claim 1, wherein an angle formed between the direction of travel of the belt and either the first fibers or the second fibers of the reinforcement fabric layer is from −5 ° to less than 0°.

7. The multi-layer reinforced belt of claim 1, wherein the material of the reinforcement fabric layer comprises interlock yarn twist (ITY) fabric.

8. The multi-layer reinforced belt of claim 1, wherein the material of the reinforcement fabric layer is selected from one or more of polyester, polyaramid, nylon, polypropylene, polyethylene, ceramic fibers, carbon fiber, and metal fibers.

9. The muti-layer reinforced belt of claim 1, wherein the reinforcement fabric layer is in contact with the plurality of cords.

10. The multi-layer reinforced belt of claim 1, wherein the main body portion comprises two or more layers of different compound materials.

11. The multi-layer reinforced belt of claim 1, wherein the main body portion comprises at least a first layer of a first compound material and a second layer of a second compound material.

12. The multi-layer reinforced belt of claim 11, wherein the first compound material is a polyurethane having a first modulus and the second compound material is a second polyurethane having a second modulus different from the first modulus.

13. The multi-layer reinforced belt of claim 1, wherein the material of the main body portion extends though the reinforcement fabric layer.

14. The multi-layer reinforced belt of claim 1, wherein a plurality of surface features are formed in the contact surface.

15. The multi-layer reinforced belt of claim 14, wherein the surface features are teeth oriented generally perpendicular to the direction of travel of the belt.

16. The multi-layer reinforced belt of claim 14, wherein the surface features are ribs oriented generally parallel to the direction of travel of the belt.

17. The multi-layer reinforced belt of claim 1, wherein the contact surface is generally planar.

18. The multi-layer reinforced belt of claim 1, wherein the multi-layer reinforced belt is a ribbed belt, a timing belt, a synchronous belt, a V-belt, a micro-V belt, a toothed belt, a friction belt, or a flat belt.
